(19) United States
(12) Patent Application Publication
(10) Pub. No.: US 2006/0226199 A1
(43) Pub. Date: Oct. 12, 2006

(54) Selective soldering of flat flexible cable with lead-free solder to a substrate

(75) Inventors: Zhong-You Shi, Ann Arbor, MI (US); Prathap A. Reddy, Farmington Hills, MI (US); Anne M. Sullivan, Dearborn, MI (US); William D. Hopfe, Farmington Hills, MI (US)

Correspondence Address: VISTEON, C/O BRINKS HOFER GILSON & LIONE, PO BOX 10395, CHICAGO, IL, 60610, US

(73) Assignee: VISTEON GLOBAL TECHNOLOGIES, INC.

(21) Appl. No.: 11/093,449

(22) Filed: Mar. 30, 2005

(51) Int. Cl. A47J 36/02

(52) U.S. Cl. 228/101

(57) ABSTRACT

A system and method for soldering flat flexible cable to an electronic substrate using lead-free solder is disclosed. The method comprises bending conductive end portions of the flat flexible cable and inserting the bent conductive end portions of the flat flexible cable through slots that extend through the thickness of the electronic substrate. In so doing, a segment of the conductive end portion will protrude through the thickness of the substrate. The method further comprises of heating the flat flexible cable to a temperature of approximately 100° C. and then applying the lead-free solder to the area where the end portion protrudes through the thickness of the substrate for a time period of approximately 5 to 9 seconds.

### BACKGROUND

The present invention relates generally to soldering of a flat flexible cable (“FFC”) to an electrical substrate and more particularly to the soldering of an FFC to an electrical substrate using a lead-free solder.

Generally, FFCs have a conductive member enclosed in a polymer sheath. When soldering an FFC to a substrate, the temperature required to melt the solder may damage the polymer sheath. Currently, FFCs are being soldered to the substrate using lead-alloy solders. However, the industry trend is towards the use of lead-free solders which have a higher melting temperature. Because of the higher melting temperature, there is a greater risk of damaging the polymer sheath of the FFC. Therefore, there exists a need for a solution that allows for the soldering of FFC to a substrate using a lead-free solder that will minimize or eliminate damage to the polymer sheath.

### BRIEF SUMMARY

In overcoming the drawbacks and limitations of the known technologies, a method and the resulting product of soldering a FFC to an electronic substrate using lead-free solder is disclosed. The substrate includes conductive traces embedded within the substrate and through holes or slots extending through the thickness of the substrate adjacent to the conductive traces. By having the slots extend through the thickness of the substrate, electrical and physical access to the copper traces is possible. The FFC includes a conductive strip encapsulated by a non-conductive sheath and an exposed end portion which is inserted into the slot. A lead-free solder bonds and electrically connects the exposed end portion to the conductive trace of the substrate.

In order to solder the FFC to an electronic substrate using lead-free solder, the exposed end portion of the flat flexible cable is inserted into the slot of the substrate such that the exposed portion passes through the entire depth of the substrate creating a target area. The flat flexible cable is then heating to a temperature of about 100° C. Finally, molten lead-free solder is applied to the target are for approximately 5 to 9 seconds.

These and other advantages, features and embodiments of the invention will become apparent from the drawings, detailed description and claims, which follow.

### BRIEF DESCRIPTION OF THE DRAWINGS

FIG. 1 is a plan view of a substrate assembly in accordance with the principles of the present invention;

FIG. 2 is a plan view of a FFC in accordance with the principles of the present invention;

FIG. 3 is a cross sectional view, generally taken along line 3-3, of the FFC seen in FIG. 2;

FIG. 4 is a schematic representation of a system for soldering the FFC to a substrate using a lead-free solder in accordance with the principles of the present invention; and

FIG. 5 a cross sectional view of a joined FFC and substrate in accordance with the principles of the present invention.

### DETAILED DESCRIPTION

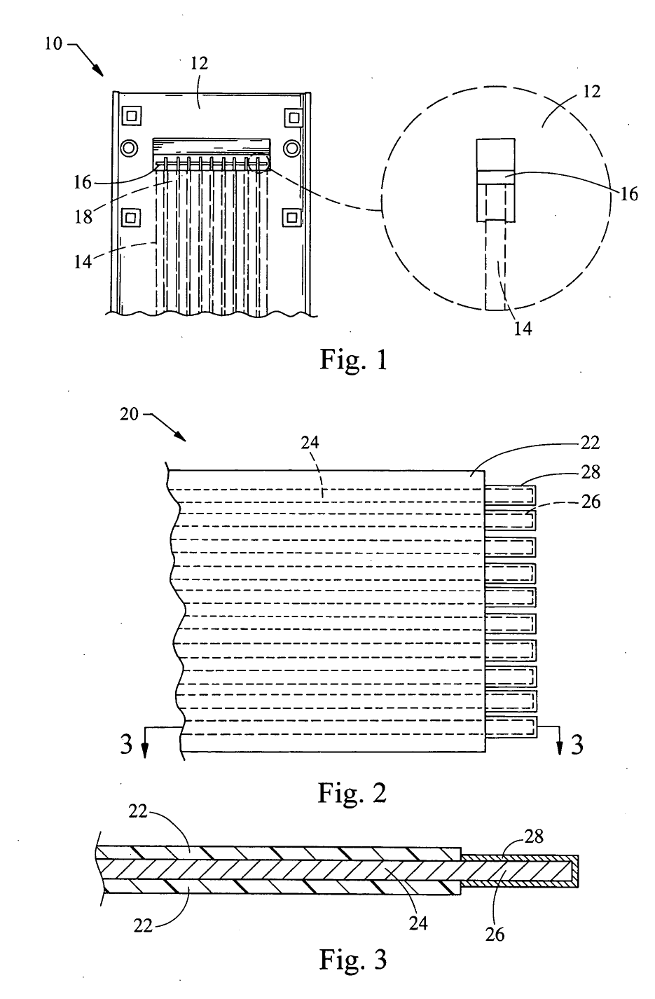

Referring now to FIG. 1, a substrate assembly 10 is shown having a substrate 12, one or more copper traces 14 (encapsulated within the substrate 12) and one or more slots 16, which are formed through the thickness of substrate 12 and border on end portions 18 of the copper traces 14. The slots 16 function to allow physical and electrical access to the end portions 18 of the copper traces 14.

The substrate 12 is made from at least one of polyimide, polyethylene naphthalate (“PEN”), polyethylene terephthalate (“PET”) and flame retardant Type 4 (“FR4”) epoxy based substate. Alternatively, any other non-conductive polymer can be used as is known in the industry or later developed. Generally, the substrate 12 is rigid, but it may be made to be flexible. The copper traces 14 are typically made of copper, but may be made of any conductive material.

Referring now to FIGS. 2 and 3, a flat flexible cable (“FFC”) 20 is shown having a sheath 22 that encapsulates copper traces 24, except for exposed end portions 26, which are not encapsulated by the sheath 22. The sheath 22 is preferably constructed from polyurethane but may be made from any non-conductive material. The exposed portions 26 are generally plated with tin 28.

The previous paragraphs described an end product of a method. The following paragraphs will describe the method for making the end product.

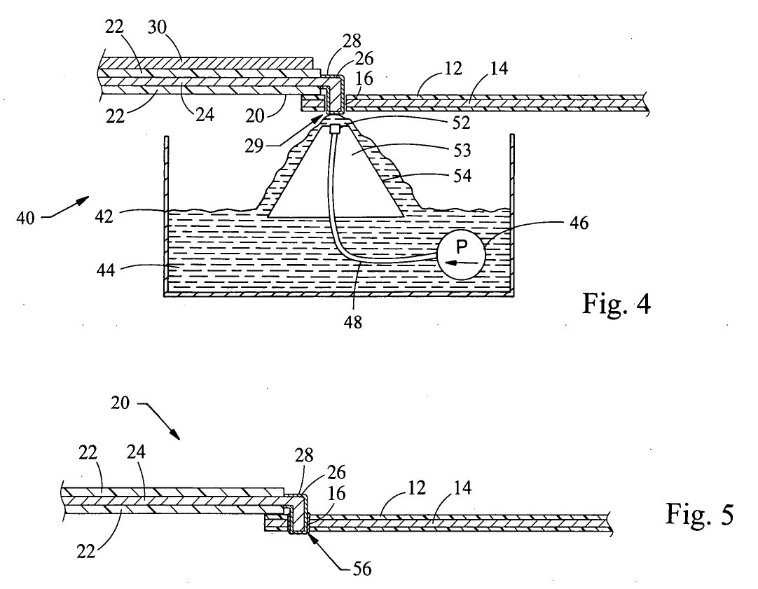

Referring now to FIG. 4, the exposed end portions 26 of the FFC 20 are bent substantially perpendicular to the encapsulated portion of the flat flexible cable 20. These bent exposed portions 26 are inserted into the slots 16 of the substrate 12 so that part of the bent exposed portion 26 passes through the entire depth of the substrate 12, creating a target area 29. A heating element 30 is placed on the encapsulated portion of the flat flexible cable 20. Alternatively, the heating element 30 may be placed on both the encapsulated portion of the FFC 20 and the substrate assembly 10, or the heating element 30 may be placed only on the substrate assembly 10. As shown, the hearing element 30 is generally a heating pad, but the FFC may be heated by using alternative devices, such as hot gas originating from a hot gas nozzle. Generally, the heating element 30 is elevated to a temperature of approximately 100° C.; however, the heating element 30 may be elevated to any temperature from about 80° C. to 120° C.

A soldering device 40 has a solder pot 42 which contains molten solder 44. The molten solder 44 is preferably a lead-free type. More specifically, the molten solder 44 includes tin with at least one of: silver and copper. The soldering device 40 further includes a pump 46 and a tube 48. The pump 46 is placed near the bottom of the solder pot 44 so that the pump 46 is immersed in the molten solder 44. The pump 46 pumps molten solder 44 through the tube 48 and out through an opening 52 at an end 53 of a nozzle 54. When in operation, the molten solder 44 pumped out the opening 52 will, by force of gravity, trickle down the end 53 of the nozzle 54 and return to the solder pot 42.

The target area 29 will then be situated near the opening 52 of the nozzle 50 such that the molten solder 44 that is flowing through the opening 52 will contact the target area 29. The force exerted on the molten solder 44 by the, pump 46 and capillary action will force an amount of molten solder 44 between end portion 26 and the copper trace 14. After about 5 to 9 seconds, the target area 29 is removed from the opening 52 of the nozzle 50 such that the molten solder 44 that is flowing through the opening 52 is not in contact with the target area 29.

The heating element 30 is then removed from the FFC 20 and the remaining solder 56 is allowed to cool. The remaining solder 56 bonds and electrically connects the end portion 26 of the FFC 20 to the copper trace 14.

The foregoing description of the embodiment of the invention has been presented for purposes of illustration and description. It is not intended to be exhaustive or to limit the invention to the precise embodiment disclosed. Numerous modifications or variations are possible in light of the above teaching. The embodiment discussed was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A substrate assembly comprising
a substrate having a conductive trace embedded therein, the substrate defining a slot adjacent to the conductive trace, wherein the slot extends through the thickness of the substrate;
a flat flexible cable having a conductive strip encapsulated by a non-conductive sheath and an exposed end portion inserted into the slot; and
a lead-free solder bonding and electrically connecting the exposed end portion to the conductive trace.

2. The substrate assembly of claim 1, wherein the end portion is plated with tin.

3. The substrate assembly of claim 1, wherein the conductive trace is constructed of copper.

4. The substrate assembly of claim 1, wherein the substrate comprises at least one of the following: polyimide, polyethylene naphthalate, polyethylene terephthalate and flame retardant type 4 epoxy based substrate.

5. The substrate assembly of claim 1, wherein the sheath is constructed of polyurethane.

6. The substrate assembly of claim 1, wherein the lead-free material is an alloy comprising tin with at least one of silver and copper.

7. A method of soldering a flat flexible cable to a substrate using a lead-free solder, the method comprising:
providing the substrate having a slot extending therethrough;
providing the flat flexible cable having a conductive strip encapsulated by a non-conductive sheath and an exposed end portion;
heating the lead-free solder to a softening temperature;
inserting an end portion of the conductive strip of the flat flexible cable into the slot;
preheating at least one of the flat flexible cable and the substrate to an elevated temperature that is below the softening temperature of the lead-free solder;
applying the lead-free solder to the end portion of the conductive strip of the flat flexible cable for a predetermined time; and
cooling the lead-free solder applied to the end portion.

8. The method of claim 7, wherein the substrate comprises at least one of the following polyimide, polyethylene naphthalate, polyethylene terephthalate and flame retardant type 4 epoxy based substrate.

9. The method of claim 7, wherein the end portion of the conductive strip protrudes through the slot, wherein the lead-free solder is applied to the protruding end portion.

10. The method of claim 7, further comprising bending the end portion of the flat flexible cable.

11. The method of claim 7, wherein the softening temperature is from about 260° C. to 270° C.

12. The method of claim 7, wherein the elevated temperature is from about 80° C. to 120° C.

13. The method of claim 7, wherein the period of time is from about 5 seconds to 9 seconds.

14. A method of soldering a flat flexible cable to a substrate using a lead-free solder, the method comprising:
providing the substrate having a slot extending therethrough;
providing the flat flexible cable having a conductive strip encapsulated by a non-conductive sheath and an exposed end portion;
heating the lead-free solder to a softening temperature;
inserting an end portion of the conductive strip of the flat flexible cable into the slot;
preheating the flat flexible cable and the substrate to an elevated temperature that is below the softening temperature of the leadfree solder;
applying the lead-free solder to the end portion of the conductive strip of the flat flexible cable for a predetermined time; and
cooling the lead-free solder applied to the end portion.

15. The method of claim 14, wherein the substrate comprises at least one of the following: polyimide, polyethylene naphthalate, polyethylene terephthalate and flame retardant type 4 epoxy based substrate.

16. The method of claim 14, wherein the end portion of the conductive strip protrudes through the slot wherein the lead-free solder is applied to the protruding end portion.

17. The method of claim 14, further comprising bending the end portion of the flat flexible cable.

18. The method of claim 14, wherein the softening temperature is from about 260° C. to 270° C.

19. The method of claim 14, wherein the elevated temperature is from about 80° C. to 120° C.

20. The method of claim 14, wherein the period of time is from about 5 seconds to 9 seconds.
